(19) United States
(12) Patent Application Publication
(10) Pub. No.: US 2022/0072950 A1
(43) Pub. Date: Mar. 10, 2022

(54) A System and Method for Enhanced Operation of Electric Vehicles

(71) Applicant: Solstice Industries Pty Ltd., Ouyen, Victoria (AU)

(72) Inventor: Neale Leslie Connor, Ouyen (AU)

(21) Appl. No.: 17/421,430

(22) PCT Filed: Jan. 9, 2020
(86) PCT No.: PCT/AU2020/050012

§ 371 Date: Jul. 8, 2021

(30) Foreign Application Priority Data
Jan. 9, 2019 (AU) 2019900068

(51) Int. Cl. B60K 16/00; B60L 50/60; B60L 53/52; B60L 58/13; B60L 53/51; F03D 9/32; F03D 9/11; F03D 9/00; H02J 7/14

(52) U.S. Cl. CPC B60K 16/00; F16H 1/06; B60L 53/52; B60L 58/13; B60L 53/51; F03D 9/32; F03D 9/11; F03D 9/007; H02J 7/1415; H02J 7/1423; B60K 2016/003; B60K 2016/006; F05B 2240/941; F05B 2220/708; B60L 50/60

(57) ABSTRACT

A system and method for enhanced operation of an electric vehicle having a main battery for powering an electric drive motor by which the vehicle is drivable, including at least one air intake device operable, in forward motion of the vehicle or when the vehicle is stationary, to capture and channel air in flow through the intake device to at least one turbine adjacent to an outlet end of the air intake device to drive the turbine(s) to generate a first electrical energy at a first energy level and/or including one or more photovoltaic solar panels integrated with or adjacent to one or more body components of the electric vehicle and the one or more photovoltaic solar panels is/are adapted to generate a/the first energy at a/the first energy level. A secondary battery pack connected to an electrical energy outlet of the turbine(s) and/or photovoltaic panels receives the electrical energy generated by the turbine(s) and/or photovoltaic panels. A first auxiliary electric motor is drivable by the secondary battery pack for rotating an output shaft of the first auxiliary electric motor. A second auxiliary electric motor having an input shaft connected to the output shaft of the first auxiliary electric motor has an output terminal connectable to the main battery of the vehicle. A transmission couples the output and input shafts and provides a rotational speed step up from the first to the second of the auxiliary electric motors, whereby the second auxiliary electric motor is drivable to generate a second electrical energy, at a second energy level higher than the first energy level, able to be supplied from the output terminal of the second auxiliary electric motor to the main battery and/or the drive motor of the vehicle.

### CROSS-REFERENCE

This Application claims the benefit of Australian Provisional Patent Application No.: 2019900068, filed on 9 Jan. 2019, the entire contents of which is incorporated herein by reference thereto.

### TECHNICAL FIELD

This invention relates to a system and method for enhanced operation of electric vehicles and, in particular for enhancing the maximum range of travel for such vehicles.

It will be convenient to hereinafter describe the invention in relation to a system and method for enhanced operation of an electric land vehicle, such as, for example, a passenger or commercial road vehicle, however it is to be appreciated that the present invention is not limited solely to that use. Instead, the system and method of the present invention may be used to enhance the operation of any suitable electric vehicle, including, but not limited to: trucks; tractors; buses; aircraft; and/or watercraft. Accordingly, unless stated otherwise, throughout the ensuing description, the term “vehicle” or “electric vehicle” is intended to refer to any suitable means in or by which someone may travel, or something may be carried or conveyed, by way of the use of, or in association with, one or more electric motors.

### BACKGROUND ART

Any discussion of documents, devices, acts or knowledge in this specification is included to explain the context of the invention. It should not be taken as an admission that any of the material forms a part of the prior art base or the common general knowledge in the relevant art in Australia, or elsewhere, on or before the priority date of the disclosure herein.

Rapid progress is being made in the development of electric batteries used for powering electric vehicles. Batteries with increasingly higher battery capacity offer the prospect for improving the maximum range of travel between successive battery charging stops, while shortening of the recharging period minimises the delays involved. However, it seems likely that for the foreseeable future the relatively short maximum range of travel is an impediment to full acceptance of fully electric vehicles.

Vehicle bodies, including those of electric vehicles, are designed to minimise the adverse effects of drag from airflow over and under the body during forward travel. However, the bodies also are designed to take in controlled air-flow, such as for brake cooling and internal air regulation and control for heating or cooling. As in the proposal of U.S. Pat. No. 5,680,032, to Pena (hereinafter “U.S. Pat. No. 5,680,032”), use of wind-power also has been proposed for recharging the batteries of electric vehicles.

In U.S. Pat. No. 5,680,032, it is proposed that during forward motion of an electric vehicle, air is captured at the front of the vehicle and channeled to one or more turbines. The air from the turbines is discharged at low-pressure regions on the sides and/or rear of the vehicle. The motive power of the air rotates the turbines, which are rotatably engaged with a generator to produce electrical energy that is used to directly recharge batteries that power the vehicle. The generator is rotatably engaged with a flywheel for storing mechanical energy while the vehicle is in forward motion. When the vehicle slows or stops, the flywheel releases its stored energy to the generators, thereby enabling the generator to continue directly recharging the batteries. The flywheel enables the generators to provide a more stable and continuous current flow for recharging the batteries.

The present invention seeks to provide an alternative to the arrangement that, at least in preferred forms of the invention, is able to further enhance recharging of the batteries of an electric vehicle relative to the proposal of U.S. Pat. No. 5,680,032.

### DISCLOSURE OF THE INVENTION

Accordingly, in one aspect, the present invention provides a system for enhanced operation of an electric vehicle having a main battery(ies) for powering an electric drive motor by which the vehicle is drivable, wherein the system includes at least one air intake device that is designed so as to be operable, while the vehicle is in forward motion or stationary, to capture air and channel the air in flow from an inlet end to an outlet end of the air intake device(s); at least one turbine positioned adjacent to the outlet end of the air intake device(s) so that the turbine(s) is/are driven by the air flow from the outlet end of the air intake device(s) and thereby caused to generate a first stage of electrical energy output at a first energy level; a secondary battery pack electrically connected to an electrical energy outlet of the turbine(s) for receiving and storing electrical energy of the first stage generated by the turbine(s); a first auxiliary electric motor drivable by being electrically connected to the secondary battery pack for rotating an output shaft of the first auxiliary electric motor; a second auxiliary electric motor having an input shaft drivingly connected to the output shaft of the first auxiliary electric motor and an output terminal connectable to the main battery(ies) of the vehicle; and a transmission coupling the output shaft to the input shaft and operable to provide a rotational speed step up from the first to the second of the auxiliary electric motors whereby the second auxiliary electric motor is drivable to generate a second stage of direct or alternating current electrical energy, at a second energy level higher than the first energy level, able to be supplied from the output terminal of the second auxiliary electric motor to the main battery(ies) and/or the drive motor of the vehicle.

In relation to the system of the invention and throughout this specification and the claims, it is to be understood that the first stage of electrical energy most conveniently is direct current. The second stage also may be direct current, in which case the respective energy levels may reflect respective voltage levels. However, the second stage may comprise alternating current, if required three-phase alternating current. Also, the system provides a step up in power from the first to the second stage of electrical energy generation, with the step up electronically or mechanically controlled, such as to preferably not to exceed 95% of capacity. The transmission between the first and second stages thus is able to be prevent the second stage from exceeding 95% of its capacity. For this there may be used a gear ratio of up to 1:50, depending on the maximum rotational speed in the second stage.

Accordingly, in a further aspect, the present invention provides a method for enhanced operation of an electric vehicle having a main battery(ies) for powering an electric drive motor by which the electric vehicle is drivable, wherein the method includes the steps of: capturing an intake of air by at least one air intake device, while the electric vehicle is in forward motion or stationary, and channeling the air in flow from an inlet end to an outlet end of the air intake device(s); positioning at least one turbine adjacent to the outlet end of the air intake device(s) to cause the turbine(s) to be driven by the air flow from the outlet end of the air intake device(s) and thereby causing the turbine(s) to generate a first stage of electrical energy at a first energy level and/or integrating with or positioning adjacently to one or more body components of the electric vehicle one or more photovoltaic solar panels and capturing sunlight via the one or more photovoltaic solar panels and thereby causing the one or more photovoltaic solar panels to generate a/the first stage of electrical energy at a/the first energy level; receiving and storing electrical energy of the first stage, generated by the turbine(s) and/or the one or more photovoltaic solar panels, by provision of a secondary battery pack electrically connected to an electrical energy outlet of the turbine(s) and/or the one or more photovoltaic solar panels; utilising power from the secondary battery pack to operate a first auxiliary electric motor; utilising the first auxiliary electric motor to drive a second auxiliary electric motor, via a transmission coupling an output shaft of the first auxiliary electric motor to an input shaft of the second auxiliary electric motor; the transmission coupling providing a rotational speed step up from the first, to the second, auxiliary electric motor whereby the second auxiliary electric motor is driven to generate a second stage of direct or alternating current electrical energy at a second energy level higher than the first energy level; and supplying electrical energy at the second energy level from an output terminal of the second auxiliary electric motor to the main battery(ies) of the electric vehicle and/or the drive motor of the electric vehicle.

Throughout this specification it is intended that references to one or more batteries, or battery packs includes reference to any energy storage means, including mechanical or electrical, capacitors, chemical composition, or any other suitable energy storage means or device.

At least the air intake device(s) and the turbine(s) are positioned adjacent to each other at a location in the electric vehicle appropriate for the capture of a suitable flow of air. The location may, and preferably is, in a forward bay of the vehicle body and positioned so as to facilitate the discharge of air after passing the turbine(s). With the air intake device(s) and the turbine(s) in the forward bay, the discharging air may pass downwardly or laterally from the forward bay. However, the air preferably is guided by the air intake device(s) and associated turbine in the fore-to-aft direction for the electric vehicle, preferably a substantially horizontal fore-to-aft direction for the electric vehicle. The secondary battery pack, and the first and second auxiliary electric motors also may be positioned adjacent to the air intake device(s) and the turbine(s), although an electric connection between the turbine(s) and the secondary battery pack, or the electric connection between the secondary battery pack and the first auxiliary electric motor, can be of a length enabling other positional arrangements.

While the system of the invention may utilise a single air intake device, the system preferably has at least two such devices. The, or each, air intake device may pass a respective air stream to at least two turbines, although there preferably is a single respective turbine for receiving a single airstream from each air intake device. With two or more turbines, each is operable to generate a respective first stage electrical energy output, with each such output substantially at a common first energy level. The secondary battery pack electrically may be connected to a respective electrical energy outlet of each of the turbines for receiving and storing an aggregate electrical energy of the first stage generated by the respective turbines.

The system of the invention may alternatively or in conjunction with the turbine(s) utilise one or more photovoltaic panels integrated into one or more body components of the electric vehicle, or otherwise disposed adjacent to one or more body components, for collecting sunlight, with each of the one or more of the photovoltaic panels being operable to generate a/the first stage of electrical energy output substantially at a common first energy level such as that generated by the turbine(s). The secondary battery pack may be electrically connected to a respective energy outlet of each of the photovoltaic panels for receiving and storing an aggregate electrical energy of the first stage generated by any respective photovoltaic panel(s) in conjunction with any respective turbine(s) or in alternative to any respective turbine(s).

The transmission that couples the output shaft of the first auxiliary electric motor to the input shaft of the second auxiliary electric motor may, and preferably does, comprise a gear system that provides the required rotational speed step up from the first to the second of the auxiliary electric motors. The gear system may comprise a spur gear system, at least when provided in a preferred arrangement in which the output shaft of the first auxiliary electric motor and the input shaft of the second auxiliary electric motor are parallel to each other. The teeth of a larger gear of the system, provided on the output shaft, may mesh with teeth of a smaller gear on the input shaft, with the teeth of the respective gears parallel to the axes of the shafts. However, a helical gear arrangement also is possible with the teeth of the respective gears inclined with respect to the shafts. Alternatively, where it is appropriate or convenient to have the output and input shafts other than parallel, such as perpendicular to each other, straight bevel gear system can be adopted. One of several more complex gear systems can be used, but generally are not required.

The gear system is selected to provide a required step up from the first energy level of the first stage of electrical energy to the second energy level of the second stage of electrical energy, such that the second energy level substantially corresponds to that of the output energy level of the main battery(ies) and required for the drive motor of the vehicle. The step up gear ratio provided by the gear system can vary with other parameters of the system of the invention. However, the gear ratio is to achieve a ratio of the speed of rotation of the input shaft of the second auxiliary electric motor to the speed of rotation of the output shaft of the first auxiliary electric motor. In each case the ratio can vary from 1:10 to 1:25 or higher, for example from 1:15 to 1:25.

The system of the invention, for enhanced operation of an electric vehicle, may include or be used in association with, circuitry for converting the second energy level of the second stage of electrical energy to a form compatible with electric drive motor of the electric vehicle or to a form suitable for supply to the motor to supplement power being supplied to the motor from the main battery(ies). The circuitry may therefore comprise a recharger device by which direct current at the second energy level of the second stage of electrical energy and direct current from the vehicle main battery(ies) are converted to three phase alternating current suitable for supply to the main battery(ies) of the electric vehicle for maintenance of the electrical energy capacity of the main battery(ies) for powering the electric vehicle.

These and other essential and/or preferred aspects and features of the present invention will be apparent from the description that now follows.

### BRIEF DESCRIPTION OF THE DRAWINGS

In order that the invention may be more clearly understood and put into practical effect there shall now be described in detail preferred constructions of a system and method for enhanced operation of electric vehicles in accordance with the invention. The ensuring description is given by way of non-limitative examples only and is with reference to the accompanying drawings, wherein:

FIG. 1 schematically illustrates a first prior art arrangement;

FIG. 2 schematically illustrates a system according to the present invention for enhanced operation of an electric vehicle;

FIG. 3 is a schematic plan view of an electric motor vehicle incorporating the system of FIG. 2 for enhanced operation of the vehicle;

FIG. 4 is a side elevation of the electric motor vehicle and system of FIG. 3;

FIG. 5 is a front-end elevation of the electric motor vehicle and system of FIG. 3;

FIG. 6 is a front-end perspective view of an electric vehicle incorporating an alternative system according to the present invention for enhanced operation of the vehicle, the system may be that of FIG. 2;

FIG. 7 shows an electric motor vehicle according to FIG. 3 or FIG. 6, showing an alternative arrangement for air-flow through the vehicle; and,

FIG. 8 corresponds to FIG. 7, but with a further alternative arrangement for air-flow through the electric motor vehicle.

### MODES FOR CARRYING OUT THE INVENTION

The following is a detailed description of the invention with reference to the preferred embodiment(s) shown in the drawings. In the detailed description and in the drawings, like reference numerals refer to like elements throughout. Those elements are intended to show by way of illustration specific embodiments in which the invention may be practiced. It is to be understood that other embodiments may be utilised and that procedural and/or structural changes may be made without departing from the spirit and scope of the invention.

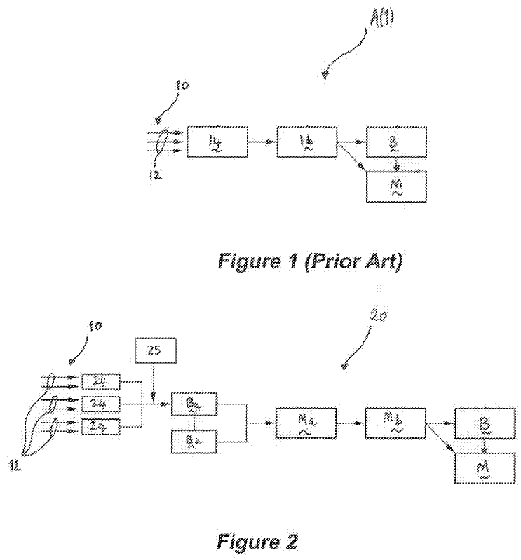

The prior art arrangement of FIG. 1 comprises an arrangement A(1) intended to assist with powering an electric vehicle (not shown) having an electric motor M powered principally by a main battery B. The arrangement A(1) includes an air intake stage 10 that comprises a single air intake duct (not shown) that generates a stream of air 12 that is directed to a generally large turbine 14. The intake stage 10 typically is in the form of a funnel (not shown) able to ensure the airflow 12 is sufficient to strongly rotate the vanes (not shown) of the turbine 14 and thereby cause turbine 14 to generate an electrical energy output, such as at a direct current voltage level sufficient for use in maintaining the energy capacity of main battery B or to assist with powering the motor M. From an output terminal of the turbine 14, the output electrical energy may be passed from the turbine 14 to a recharger device 16. The direct current from the turbine 14 may be converted by the recharger device 16 to three phase alternating current suitable for powering the motor M. Thus, from the converter of the recharger device 16, the alternating current may be supplied direct to the vehicle motor M to supplement energy being supplied to the motor M, via the recharger 16, from the main battery B.

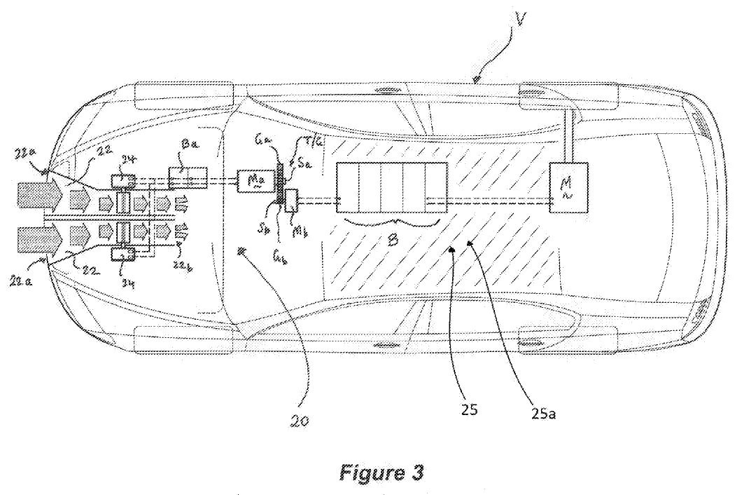

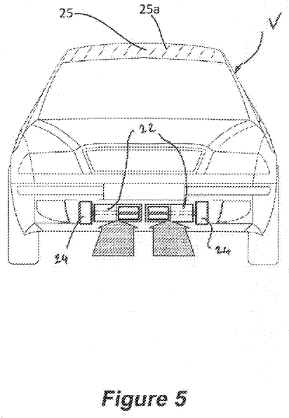

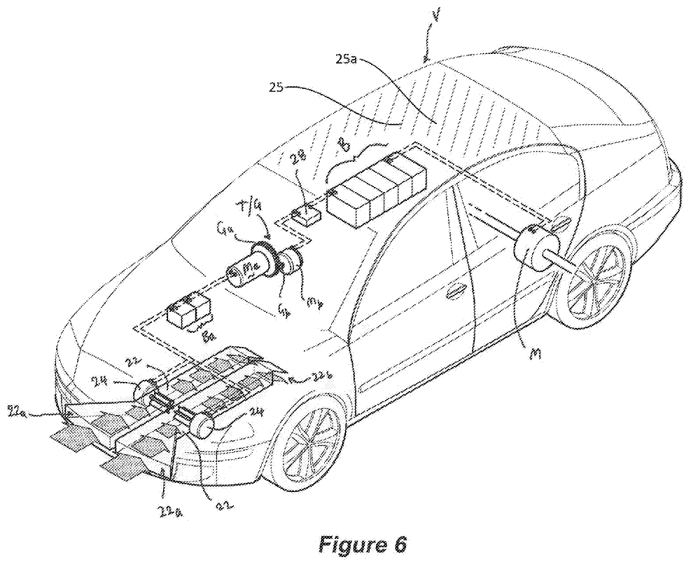

FIG. 2 schematically illustrates a system 20 made in accordance with a preferred embodiment of the present invention for enhanced operation of an electric vehicle (not shown). The arrangement of system 20 is also intended to assist with powering an electric vehicle (not shown) having an electric motor M powered principally by a main battery or batteries B. However, unlike the prior art arrangement A(1) of FIG. 1, the arrangement of system 20 of the present invention includes an air intake stage 10 that comprises multiple air intake ducts (not shown) each of which generates a respective stream of air 12 that is directed to a respective one of multiple turbines 24. Each air intake duct (not shown) of the intake stage 10 typically is in the form of a funnel (not shown) able to ensure a respective airflow 12 is sufficient to strongly rotate the vanes (not shown) of the respective turbine 24 and thereby causes the turbines 24 to generate an electrical energy output at a first stage electrical energy level, such as at a direct current electrical energy output at a first energy level. The arrangement of system 20 also may preferably include, in conjunction with or in the alternative to the turbine(s), at least one photovoltaic panel 25 adjacent to or integrated with at least one body component 25a, such as, for example, a body panel 25a as shown in FIGS. 3 to 8, to capture sunlight (not shown) to generate an electrical energy output at a/the first stage electrical energy level, such as at a direct current electrical energy output at a/the first energy level. The current of the first stage energy output is supplied to secondary battery(ies) Ba to maintain the energy capacity of batteries Ba at a level providing power to drive a first auxiliary electric motor Ma. With power from the secondary batteries Ba, first auxiliary electric motor Ma is operable by a transmission coupling to drive a second auxiliary electric motor Mb which then generates an electrical energy output at a second stage electrical energy level, such as at a direct or alternating current electrical energy output, at a second energy level higher than the first energy level and sufficient for use in maintaining the energy capacity of main battery(ies) B or to assist with powering the motor M, such as at a second stage voltage level higher than a first stage voltage level. Although not shown, from an output terminal of the second auxiliary electric motor Mb, the output electrical energy may be passed to a recharger device 28 (see, for example, FIG. 6). For example, direct current from the second auxiliary electric motor Mb may be supplied to the vehicle main battery(ies) B for maintenance of the energy capacity level of the main battery(ies) B, or converted by the preferred recharger device 28 to three phase alternating current suitable for supply for powering the motor M. Thus, from the preferred recharger device 28, direct current may be supplied direct to main battery(ies) B, or the direct current may be converted, by a converter of the recharger device 28, to alternating current for direct supply to the vehicle motor M to supplement energy being supplied to the motor M from the main battery(ies) B.

FIGS. 3 to 6 illustrate preferred embodiments of how system 20 of FIG. 2 may be incorporated within an electric vehicle V. As already outlined above, system 20 enables enhanced operation of an electric vehicle V having a main battery or bank of batteries B for powering an electric drive motor M by which the vehicle V is drivable. The system 20 includes at least one air intake device 22 that is designed so as to be operable, while the vehicle V is in forward motion or stationary, to capture air and channel the air in flow from an inlet end 22a to an outlet end 22b of the air intake device 22. The system 20 also includes at least one, or a respective, turbine 24 positioned adjacent to the outlet end 22b of the, or each, air intake device 22, so that the vanes of the, or each, turbine 24 is/are driven by the air flow from the outlet end 22b of the air intake device 22 and/or at least one photovoltaic panel 25 adjacent to or integrated with the at least one body panel 25a to capture sunlight (not shown) and thereby caused to generate a/the first stage preferred direct current electrical energy output at a/the first energy level. A secondary battery pack Ba of system 20 is electrically connected to an electrical energy outlet terminal of the or each turbine 24 for receiving and storing electrical energy of the first stage generated by the turbine(s) 24. Also, a first auxiliary electric motor Ma is drivable by being electrically connected to the secondary battery pack Ba for rotating an output shaft Sa of the first auxiliary motor Ma. Adjacent to the first auxiliary motor Ma, system 20 further includes a second auxiliary electric motor Mb having an input shaft Sb drivingly connected to the output shaft Sa of the first auxiliary motor Ma and an output terminable connectable to the main battery B of the electric vehicle V. A transmission T couples the output shaft Sa (of the first auxiliary motor Ma) to the input shaft Sb (of the second auxiliary motor Mb) and is operable to provide a rotational speed step up from the first auxiliary motor Ma to the second auxiliary motor Mb. The arrangement is such that the second auxiliary motor Mb is drivable to generate a second stage of electrical energy, at a second energy level higher than the first energy level, that is able to be supplied from the output terminal of the second auxiliary motor Mb to the main battery B and/or the drive motor M of the electric vehicle V, such as at a second stage voltage level higher than a first stage voltage level.

Thus, the invention enables a method for enhanced operation of the electric vehicle V. The method includes the steps of:

(i) capturing an intake of air by at least one air intake device 22, while the electric vehicle V is in forward motion or stationary;

(ii) channeling the air in flow from an inlet end 22a to an outlet end 22b of the air intake device 22 to at least one turbine 24 positioned adjacent to the outlet end 22b of the air intake device 22 to cause the turbine(s) 24 to be driven by the air flow from the outlet end 22b of the air intake device 22 and thereby causing the turbine(s) 24 to generate a first stage of preferred direct current electrical energy at a first energy level;

(iii) and alternatively or in conjunction with step (ii), capturing sunlight (not shown) by the at least one photovoltaic panel 25 adjacent to or integrated with the at least one body panel 25a to generate a/the first stage of preferred direct current electrical energy at a/the first energy level;

(iv) receiving and storing electrical energy of the first stage, generated by the turbine(s) 24 and/or by the at least one photovoltaic panel 25 adjacent to or integrated with the at least one body panel 25a, by provision of a secondary battery pack Ba electrically connected to an electrical energy outlet of the turbine(s) 24 and/or the at least one photovoltaic panel 25;

(v) utilising power from the secondary battery pack Ba to operate a first auxiliary electric motor Ma;

(vi) utilising the first auxiliary motor Ma to drive a second auxiliary electric motor Mb, via a transmission T that couples an output shaft Sa of the first auxiliary motor Ma to an input shaft Sb of the second auxiliary motor Mb, whereby the transmission T provides a rotational speed step up from the first auxiliary electric motor Ma to the second auxiliary electric motor Mb such that the second auxiliary electric motor Mb is driven to generate a second stage of electrical energy at a second energy level higher than the first energy level; and,

(vii) supplying electrical energy at the second energy level from an output terminal of the second auxiliary electric motor Mb to the main battery B of the electric vehicle V and/or to the drive motor M of the electric vehicle V.

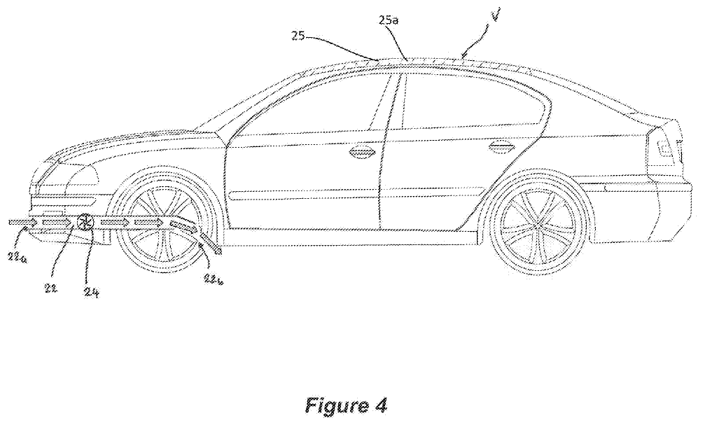

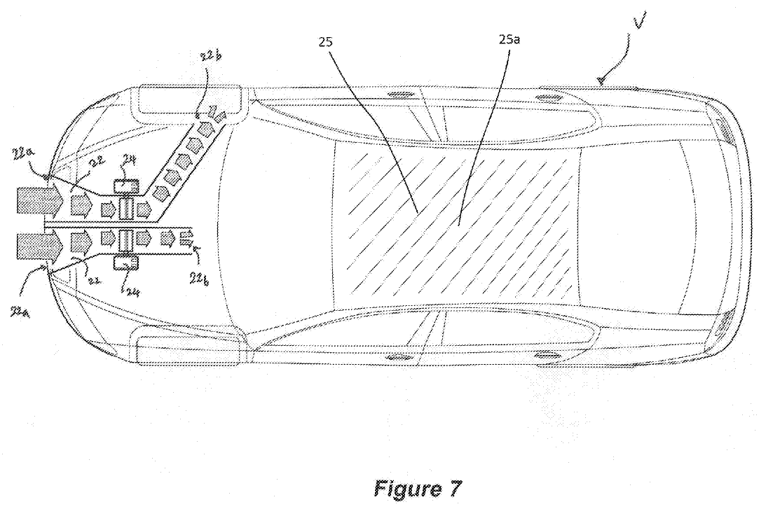

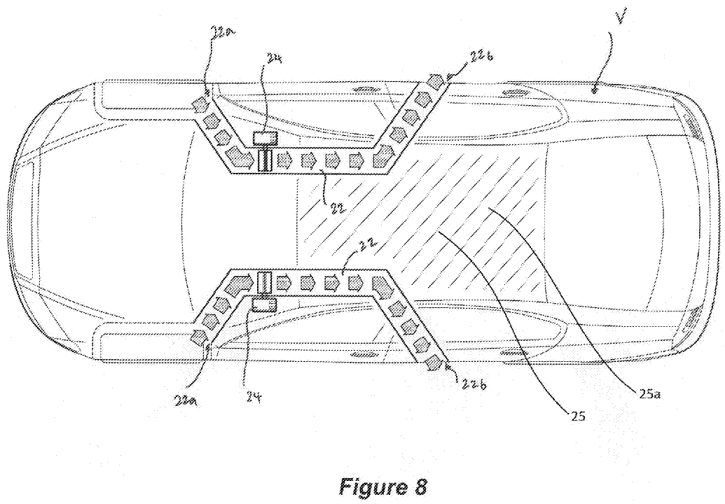

At least the, or each, air intake device 22 and the, or each, turbine 24 are positioned adjacent to each other at a location in the electric vehicle V appropriate for the capture of a suitable flow of air. As shown, the location preferably is in the forward bay of the vehicle body and positioned so as to facilitate the discharge of air after passing the turbine(s) 24. With the air intake device 22 and the turbine(s) 24 in the forward bay, the discharging air may pass downwardly from the forward bay, as shown in FIGS. 4 and 6, or downwardly and/or laterally from the forward bay as shown in FIG. 7 (e.g. air discharged laterally to the forward wheel wells which may aid in cooling the vehicles V braking systems (not shown), etc.); although other arrangements are possible as shown in FIG. 8 (e.g. air intake laterally, and air discharge laterally, etc.). In any event, the air is preferably received through the forward end of the electric vehicle V, as shown in each of FIGS. 3 to 8, and is guided by the air intake device 22 and associated turbine 24 in the fore-to-aft direction for the vehicle V, preferably a substantially horizontal fore-to-aft direction for the vehicle V. The secondary battery pack Ba, and the first and second auxiliary electric motors Ma and Mb also may be positioned adjacent to the air intake device 22 and the turbine(s) 24 although, as shown in FIGS. 3 and 6, an electric connection between the turbine(s) 24 and the battery pack Ba, or the electric connection between the battery pack Ba and the first auxiliary motor Ma, can be of a length enabling other positional arrangements.

While the system 20 of the invention may utilise a single air intake device 22, the system 20 preferably has at least two such devices 22, as shown. The, or each, air intake device 22 may pass a respective air stream to at least two turbines 24, although there preferably is a single respective turbine 24 for receiving a single airstream from each air intake device 22. With two or more turbines 24, each is operable to generate a respective first stage electrical energy output, most preferably with each such output substantially at a common energy level, such as at a common first voltage level. The secondary battery pack Ba may be connected electrically to a respective electrical energy outlet of each of the turbines 24 for receiving and storing an aggregate electrical energy of the first stage generated by the respective turbines 24.

The transmission T that couples the output shaft Sa of the first auxiliary electric motor Ma to the input shaft Sb of the second auxiliary electric motor Mb may, and preferably does, comprise a gear system G that provides the required rotational speed step up from the first auxiliary electric motor Ma to the second auxiliary electric motor Mb. The gear system G may comprise a spur gear system, as shown, at least when provided in a preferred arrangement in which the output shaft Sa of the first auxiliary electric motor Ma and the input shaft Sb of the second auxiliary electric motor Mb are parallel to each other. The teeth of a larger gear Ga of the gear system G, provided on the output shaft Sa (of the first auxiliary electric motor Ma), mesh with teeth of a smaller gear Gb on the input shaft Sb (of the second auxiliary electric motor Mb), with the teeth of the respective gears Ga and Gb parallel to the axes of the shafts Sa and Sb. However, a helical gear arrangement also is possible with the teeth of the respective gears inclined with respect to the shafts Sa and Sb. Alternatively, where it is appropriate or convenient to have the output and input shafts Sa and Sb other than parallel, such as perpendicular to each other, a straight bevel gear system could be adopted. One of several more complex gear systems may also be used, but generally are not required.

The gear system G, of transmission T, is selected to provide a required step up from the first energy level of the first stage of electrical energy to the second energy level of the second stage of electrical energy, such that the second energy level substantially corresponds to that of the output energy level of the main battery B and required for the drive motor M of the electric vehicle V. The step up gear ratio provided by the gear system G can vary with other parameters of the system 20 of the invention. However, the gear ratio is to achieve a ratio of the speed of rotation of the input shaft Sb of the second auxiliary electric motor Mb to the speed of rotation of the output shaft Sa of the first auxiliary electric motor Ma. In each case the ratio can vary from 1:10 to 1:25 or higher, for example from 1:15 to 1:25.

With both the system 20 and the method of the present invention, enhanced operation of an electric vehicle V may involve use in association with circuitry for converting the direct current of both the second energy level of the second stage of electrical energy and the vehicle main battery B to a form suitable for powering the electric drive motor M of the electric vehicle V. The circuitry may therefore comprise a recharger device 28 (see, for example, FIG. 6) by which direct current at the second energy level of the second stage of electrical energy, and also the direct current from the main battery B, is converted to three phase alternating current suitable for powering the electric vehicle V. Thus, from the recharger device 28, the alternating current may be supplied to the vehicle motor M. Where, for example, the vehicle motor M comprises a synchronous permanent magnet alternation current motor M, the recharger 28 will include an inverter to convert the respective sources of direct current to three phase alternating current required by the motor M.

The present invention therefore provides a new and useful system 20 and method for enhanced operation of electric vehicles V. Instead of using one or more large turbines 24 and/or photovoltaic panels 25 to directly charge a vehicles V main battery(ies) B, and/or to directly power the vehicles V drive motor M, the system 20 and method of the present invention utilises auxiliary batteries Ba and electric motors Ma, Mb, positioned intermediate of the one or more turbines 24 and/or photovoltaic panels 25 and the vehicles V main battery(ies) B and/or drive motor M, which facilitates the use of smaller turbines 24 and/or photovoltaic panels 25 and enables the components of the system 20 to be distributed throughout the vehicle V as desired.

While this invention has been described in connection with specific embodiments thereof, it will be understood that it is capable of further modification(s). The present invention is intended to cover any variations, uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the attached claims. Various modifications and equivalent arrangements are intended to be included within the spirit and scope of the invention. Therefore, the specific embodiments are to be understood to be illustrative of the many ways in which the principles of the present invention may be practiced.

Where the terms “comprise”, “comprises”, “comprised” or “comprising” are used in this specification, they are to be interpreted as specifying the presence of the stated features, integers, steps or components referred to, but not to preclude the presence or addition of one or more other features, integers, steps, components to be grouped therewith.

1. A system for enhanced operation of an electric vehicle having a main battery(ies) for powering an electric drive motor by which the vehicle is drivable, wherein the system includes at least one air intake device that is designed so as to be operable, while the vehicle is in forward motion or stationary, to capture air and channel the air in flow from an inlet end to an outlet end of the air intake device(s); at least one turbine positioned adjacent to the outlet end of the air intake device(s) so that the turbine(s) is/are driven by the air flow from the outlet end of the air intake device(s) and thereby caused to generate a first stage of electrical energy output at a first energy level; a secondary battery pack electrically connected to an electrical energy outlet of the turbine(s) for receiving and storing electrical energy of the first stage generated by the turbine(s); a first auxiliary electric motor drivable by being electrically connected to the secondary battery pack for rotating an output shaft of the first auxiliary electric motor; a second auxiliary electric motor having an input shaft drivingly connected to the output shaft of the first auxiliary electric motor and an output terminal connectable to the main battery(ies) of the vehicle; and a transmission coupling the output shaft to the input shaft and operable to provide a rotational speed step up from the first to the second of the auxiliary electric motors whereby the second auxiliary electric motor is drivable to generate a second stage of direct or alternating current electrical energy, at a second energy level higher than the first energy level, able to be supplied from the output terminal of the second auxiliary electric motor to the main battery(ies) and/or the drive motor of the vehicle.

2. The system of claim 1, wherein the air intake device(s) and the turbine(s) are positioned adjacent to each other at a location in the electric vehicle appropriate for the capture of a suitable flow of air, such as in a forward bay of the electric vehicle body and positioned so as to facilitate the discharge of air after passing the turbine(s) with discharging air able to pass downwardly or laterally from the forward bay.

3. The system of claim 1, wherein the air is guided by the air intake device(s) and associated turbine in the fore-to-aft direction for the electric vehicle, such as in a substantially horizontal fore-to-aft direction for the electric vehicle.

4. The system of claim 1, wherein the secondary battery pack, and the first and second auxiliary electric motors are positioned adjacent to the air intake device(s) and the turbine(s), optionally with an electric connection between the turbine(s) and the secondary battery pack, or the electric connection between the secondary battery pack and the first auxiliary motor, of a length enabling other positional arrangements.

5. The system of claim 1, including at least two air intake devices, with each, air intake device able to pass a respective air stream to at least one turbine, with each of two or more turbines operable to generate a respective first stage electrical energy output, with each such output substantially at a common first energy level.

6. The system of claim 5, wherein the secondary battery pack is electrically connected to a respective electrical energy outlet of each of the turbines for receiving and storing an aggregate electrical energy of the first stage generated by the respective turbines.

7. The system of claim 1, wherein the transmission that couples the output shaft of the first auxiliary electric motor to the input shaft of the second auxiliary electric motor comprises a gear system that provides the required rotational speed step up from the first to the second of the auxiliary electric motors.

8. The system of claim 7, wherein the output shaft of the first auxiliary electric motor and the input shaft of the second auxiliary electric motor are parallel to each other and the gear system comprises a spur gear system in which teeth of a larger gear of the system, provided on the output shaft, mesh with teeth of a smaller gear on the input shaft, with the teeth of the respective gears parallel to the axes of the shafts, or a helical gear arrangement with the teeth of the respective gears inclined with respect to the shafts.

9. The system of claim 7, wherein the output and input shafts are other than parallel, such as perpendicular to each other, and the gear system comprises a straight bevel gear system.

10. The system of claim 7, wherein the gear system is selected to provide a required step up from the first energy level of the first stage of electrical energy to the second energy level of the second stage of electrical energy, such that the second energy level substantially corresponds to that of the main battery(ies) and required for the drive motor of the electric vehicle.

11. The system of claim 10, wherein the step up gear ratio provided by the gear system achieves a ratio of the speed of rotation of the input shaft of the second auxiliary electric motor to the speed of rotation of the output shaft of the first auxiliary electric motor of from 1:10 to 1:25 or higher, such as from 1:15 to 1:25.

12. The system of claim 1, wherein the system includes, or is adapted to be used in association with, circuitry for converting the second energy level of the second stage of electrical energy to a form compatible with electric drive motor of the electric vehicle or to a form suitable for supply to the motor to supplement power being supplied to the motor from the main battery(ies).

13. The system of claim 12, wherein the circuitry comprises a recharger device by which a preferred direct current at the second energy level of the second stage of electrical energy and direct or alternating current from the electric vehicle main battery(ies) are converted to three phase alternating current suitable for supply to the main battery(ies) of the electric vehicle for maintenance of the electrical energy capacity of the main battery(ies) for powering the electric vehicle.

14. The system of claim 1, wherein the system further includes in conjunction with the turbine(s) one or more photovoltaic solar panels integrated with or adjacent to one or more body components of the electric vehicle and the one or more photovoltaic solar panels is/are adapted to generate a further first stage of electrical energy output at the first energy level.

15. A method for enhanced operation of an electric vehicle having a main battery(ies) for powering an electric drive motor by which the electric vehicle is drivable, wherein the method includes the steps of: capturing an intake of air by at least one air intake device, while the electric vehicle is in forward motion or stationary, and channeling the air in flow from an inlet end to an outlet end of the air intake device(s); positioning at least one turbine adjacent to the outlet end of the air intake device(s) to cause the turbine(s) to be driven by the air flow from the outlet end of the air intake device(s) and thereby causing the turbine(s) to generate a first stage of electrical energy at a first energy level and integrating with or positioning adjacently to one or more body components of the electric vehicle one or more photovoltaic solar panels and capturing sunlight via the one or more photovoltaic solar panels and thereby causing the one or more photovoltaic solar panels to generate a further first stage of electrical energy at a/the first energy level; receiving and storing electrical energy of the first stages, generated by the turbine(s) and the one or more photovoltaic solar panels, by provision of a secondary battery pack electrically connected to an electrical energy outlet of the turbine(s) and the one or more photovoltaic solar panels; utilising power from the secondary battery pack to operate a first auxiliary electric motor; utilising the first auxiliary electric motor to drive a second auxiliary electric motor, via a transmission coupling an output shaft of the first auxiliary electric motor to an input shaft of the second auxiliary electric motor; the transmission coupling providing a rotational speed step up from the first, to the second, auxiliary electric motor whereby the second auxiliary electric motor is driven to generate a second stage of direct or alternating current electrical energy at a second energy level higher than the first energy level; and supplying electrical energy at the second energy level from an output terminal of the second auxiliary electric motor to the main battery(ies) of the electric vehicle and/or the drive motor of the electric vehicle.
